(19) United States
(12) Patent Application Publication
(10) Pub. No.: US 2010/0169094 A1
(43) Pub. Date: Jul. 1, 2010

(54) SPEAKER ADAPTATION APPARATUS AND PROGRAM THEREOF

(75) Inventors: Masami Akamine, Kanagawa (JP); Jitendra Ajmera, Karnataka (IN); Partha Lal, Edinburgh (GB)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/561,445

(22) Filed: Sep. 17, 2009

(30) Foreign Application Priority Data
Dec. 25, 2008 (JP) 2008-330095

(51) Int. Cl. G10L 15/06; G10L 15/14

(52) U.S. Cl. 704/244; 704/256.1; 704/E15.014; 704/E15.007

(57) ABSTRACT

A speaker adaptation apparatus includes an acquiring unit configured to acquire an acoustic model including HMMs and decision trees for estimating what type of the phoneme or the word is included in a feature value used for speech recognition, the HMMs having a plurality of states on a phoneme-to-phoneme basis or a word-to-word basis, and the decision trees being configured to reply to questions relating to the feature value and output likelihoods in the respective states of the HMMs, and a speaker adaptation unit configured to adapt the decision trees to a speaker, the decision trees being adapted using speaker adaptation data vocalized by the speaker of an input speech.

### CROSS-REFERENCE TO RELATED APPLICATIONS

This application is based upon and claims the benefit of priority from the prior Japanese Patent Application No. 2008-330095, filed on Dec. 25, 2008; the entire contents of which are incorporated herein by reference.

### FIELD OF THE INVENTION

The present invention relates to a technology of speaker adaptation to a decision tree used for speech recognition.

### DESCRIPTION OF THE BACKGROUND

In general, a speech recognition system is composed of HMMs (Hidden Markov Models), and respective HMMs are coordinated with phonemes in one-to-one correspondence. States of the HMMs each include a model which represents a distribution of an acoustic feature value, and output a likelihood of the acoustic feature value of each state. Model parameters of the HMMs, that is, distribution parameters of the acoustic feature values are learned using data on many speakers, and serve as models which do not depend on speakers so as to allow recognition of speech of a given speaker, in other words, speaker-independent models. In contrast, it is well known that if the model parameter is modified to adapt data of a speaker as a target of recognition, recognition performance is apparently improved.

As regards a speech recognition system in the related art in which the distribution of the acoustic feature value corresponding to the state of the HMM is modeled by Gaussian Mixture Models (hereinafter, referred to as “GMMs”, a number of algorithms for adapting parameters of GMMs to data of new speakers are developed, and improvement of the recognition performance is reported (see Woodland, Phil C. (2001): “Speaker adaptation for continuous density HMMs: A review”, Invited Lecture, In Adaptation-2001, 11-19).

However, as regards acoustic models on the basis of decision trees shown in Teunen, R. and Akamine, A: “HMM-based speech recognition using decision trees instead of GMMs”, INTERSPEECH-2007, 2097-2100 (hereinafter, referred to as “Teunen et al.), a method of speaker adaptation does not exist thus far. It is because the acoustic models on the basis of the decision trees are not parametric models in contrast to the GMMs, and hence the adapting method on the basis of the models such as the GMMs cannot be applied simply.

In other words, in order to improve the performance of the speech recognition for data of new speakers who are not included in data for leaning, speaker adaptation which adapts the parameters of the acoustic recognition to the speaker data is effective, and a method and an effect of the speaker adaptation for the acoustic models on the basis of the GMMs are proved by many researchers so far.

In contrast, acoustic models on the basis of the decision trees are proposed recently, and the fact that these models which are able to handle totally not only the acoustic feature values, but also non-acoustic feature values which affect the acoustic feature values such as a gender of the speaker, a type of ambient noise and a state of a decoder and hence have a potential to achieve a higher recognition performance than the acoustic models on the basis of the GMMs in the related art is shown (see JP-A-2008-76730).

However, the acoustic models on the basis of the decision trees are affected by changes of speakers as with the GMMs, and the performance might be deteriorated depending on the speakers. In the case of the GMMs, various methods of speaker adaption are proposed as described above, and hence such deterioration of the performance due to the changes of the speakers is improved by the speaker adaptation.

The acoustic models on the basis of the decision trees are new models developed recently, and are not parametric models like the GMMs or even not based on the assumption of distributions of acoustic feature values, so that the method of the speaker adaption developed on the basis of the GMMs cannot be applied simply, and hence the method of the speaker adaptation does not exist.

In view of such problems as described above, it is an object of the invention to adapt decision trees to speaker adaptation data vocalized by a speaker of an input speech.

### SUMMARY OF THE INVENTION

According to embodiments of the present invention, there is provided a speaker adaptation apparatus including an acquiring unit configured to acquire an acoustic model including HMMs and decision trees for estimating what type of the phoneme or the word is included in a feature value used for speech recognition, the HMMs having a plurality of states on a phoneme-to-phoneme basis or a word-to-word basis, and the decision trees being configured to reply to questions relating to the feature value and output likelihoods in the respective states of the HMMs; and a speaker adaptation unit configured to adapt the decision trees to a speaker, the decision trees being adapted using speaker adaptation data vocalized by the speaker of an input speech.

According to the invention, the speaker adaptation of the decision trees to the speaker adaptation data vocalized by the speaker of the input speech is achieved.

### BRIEF DESCRIPTION OF THE DRAWINGS

FIG. 1 is a block diagram showing a configuration of hardware of a speech recognition apparatus having a speaker adaptation apparatus according to a first embodiment;

FIG. 2 is a block diagram showing a functional configuration of the speech recognition apparatus having the speaker adaptation apparatus according to the first embodiment;

FIG. 3 is an explanatory drawing showing an example of a data structure of an HMM;

FIG. 4 is an explanatory drawing showing a relationship between the HMM and a decision tree;

FIG. 5 is an explanatory drawing showing a configuration of the decision tree;

FIG. 6 is an explanatory drawing showing a detailed example of the decision tree;

FIG. 7 is a flowchart showing a flow of a model likelihood calculating process with respect to a feature value of an acoustic model on the basis of the decision tree;

FIG. 8 is an explanatory drawing showing a state of leaning data which reaches respective nodes and leaves of the decision tree;

FIG. 9 is a flowchart of a learning process which reaches the respective nodes and the leaves of the decision tree.

FIG. 10 is an explanatory drawing showing an adapting method of the speaker adaptation apparatus according to the first embodiment of the invention;

FIG. 11 is an explanatory drawing showing the adapting method of the speaker adaptation apparatus according to a second embodiment of the invention;

FIG. 12 is an explanatory drawing showing the adapting method of the speaker adaptation apparatus according to a third embodiment of the invention; and

FIG. 13 is a flowchart of the speaker adaptation apparatus according to the third embodiment of the invention.

### DETAILED DESCRIPTION OF THE INVENTION

### First Embodiment

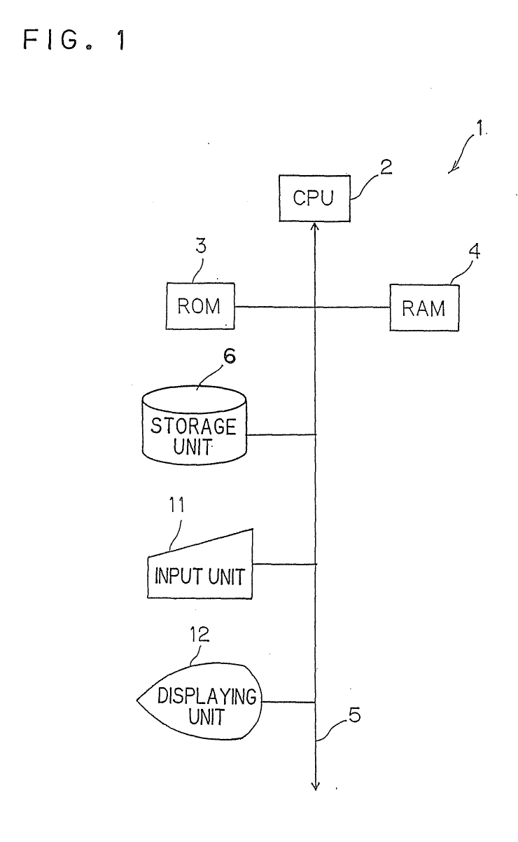

Referring now to FIG. 1 to FIG. 10, a speech recognition apparatus 1 having a speaker adaptation apparatus according to a first embodiment of the invention will be descried.

FIG. 1 is a block diagram exemplifying a hardware configuration of the speech recognition apparatus 1 according to the first embodiment. The speech recognition apparatus 1 is configured roughly to perform a speech recognition process using a self-optimized acoustic model (hereinafter referred to as “acoustic model”), and the speaker adaptation apparatus is configured to perform speaker adaptation on the acoustic model.

As shown in FIG. 1, the speech recognition apparatus 1 is, for example, a computer, and includes a CPU 2 which is a principal portion of the computer and controls respective units. A ROM 3 and a RAM 4 are connected to the CPU 2 via a bus 5. A storage unit 6 configured to store various programs and data, an input unit 11 configured to issue various operation instructions, and a displaying unit 12 are connected to the bus 5 via an I/O, not shown.

The storage unit 6 may be a recording medium of various types, for example, various optical disks such as CD-ROMs and DVDs, various magnet disks such as magneto-optic discs and flexible discs, and semiconductor memories. It is also possible to download a program via a network via a communication control apparatus and store the same in the storage unit 6. The storage unit may be connected to an outside of the speech recognition apparatus 1 so as to be communicatable. The CPU 2 causes the speech recognition apparatus 1 to execute various processes on the basis of the program stored in the storage unit 6.

Subsequently, characteristic functions of the speech recognition apparatus 1 in the first embodiment from among functions that the various programs stored in the storage unit 6 of the speech recognition apparatus 1 execute via the CPU 2 will be described.

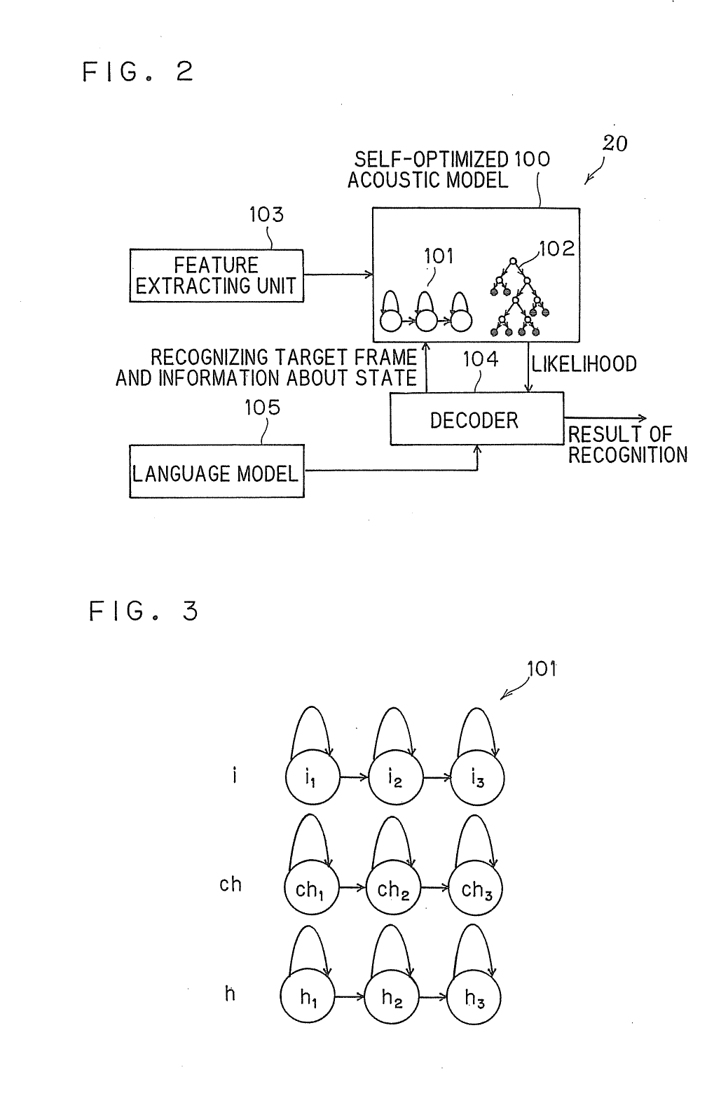

FIG. 2 is a block diagram showing a configuration of a speaker adaptation apparatus 20. As shown in FIG. 2, the speaker adaptation apparatus 20 is, for example, a program stored in the storage unit 6 of the speech recognition apparatus 1 shown in FIG. 1 and may be executed by the CPU 2. The speaker adaptation apparatus 20 may be configured as hardware. The speaker adaptation apparatus 20 includes an acquiring unit 100 as a speaker adapting unit, a feature extracting unit 103, and a decoder 104 as a speech recognizing unit.

The feature extracting unit 103 analyzes and extracts a feature value used for a speech recognition from an input speech and outputs the same to the acquiring unit 100. As examples of the feature values, a non-acoustic features such as a gender of a speaker, a phonemic context, etc. may be used as well as various acoustic features. For example, a thirty-nine dimensional acoustic feature value that is a combination of static feature values of Mel frequency cepstrum coefficients (MFCCs) or perceptual linear predictive (PLP) static feature values, Δ (primary differentiation) and ΔΔ (secondary differentiation) parameters, and energy parameters, those are used in the conventional speech recognition method, or a high-order non acoustic feature values of a class of gender or a class of the Signal to Noise Ratio (SNR) of an input speech may be used as the feature value.

The acoustic model includes a hidden Markov model (HMM) 101 as a general acoustic model and a decision tree 102, which is a tree diagram that is hierarchized at each branch. In the HMM101, one or more decision tree (s) 102 corresponds to Gaussian mixture models (GMMs) used as the feature value of each state of the conventional HMM. The decision tree 102 corresponds to an optimizing unit. The acoustic model as described above is used for calculating a likelihood 203 of the state of the HMM 101 with respect to a speech feature value input from the feature extracting unit 103. The likelihood 203 denotes the plausibility of a model, i.e., how the model explains a phenomenon and how often the phenomenon occurs with the model.

A language model 105 is a stochastic model for estimating the types of contexts each word is used. The language model 105 is identical to that is used in the conventional speech recognition process of HMM system.

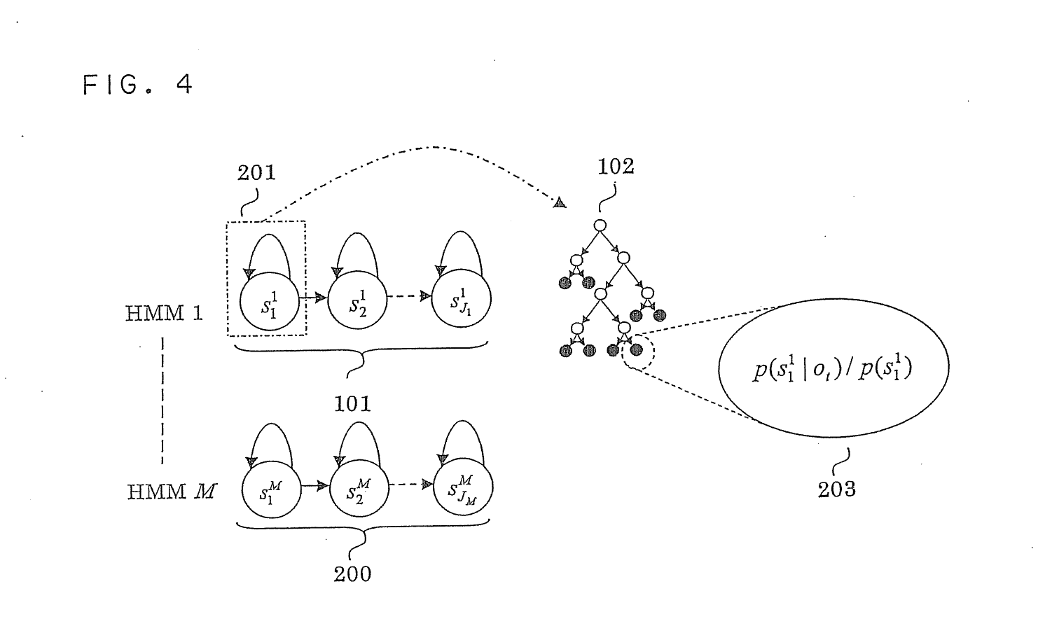

The decoder 104 has a function as a speech recognition unit, and calculates the likelihood to determine a recognized word having the highest likelihood 203 (see FIG. 4) from the acoustic model and the language model 105. More specifically, upon reception of the likelihood 203 from the acoustic model of the acquiring unit 100, the decoder 104 transmits information about a recognizing target frame such as a phonemic (or word) context of a state of the HMM 101 and a state of the speech recognition in the decoder 104 to the acquiring unit 100. The phonemic context denotes a portion of a string of phonemes that compose a word. The acquiring unit 100 also has a function as a speaker adaptation unit in the speaker adaptation apparatus.

Subsequently, the HMM 101 and the decision tree 102 which constitute the acoustic model will be described in detail.

In the HMM 101, feature value time-series data and a label of each phoneme output from the feature extracting unit 103 are recorded in associated manner. FIG. 3 is an explanatory drawing showing an example of a data structure of the HMM 101. As shown in FIG. 3, the HMM 101 expresses the feature value-time-series data by a finite automaton that includes nodes and directed links. The nodes each indicate a state of verification and, for example, the respective node values i₂, i₃ corresponding to a phoneme i are different from each other. Each of the directed links is associated with the state transition probability (not shown) between states.

FIG. 4 shows a relationship between the HMM 101 and the decision tree 102.

Each of the HMM 101 includes a plurality of states 201, and each of the states 201 is associated with one decision tree 102.

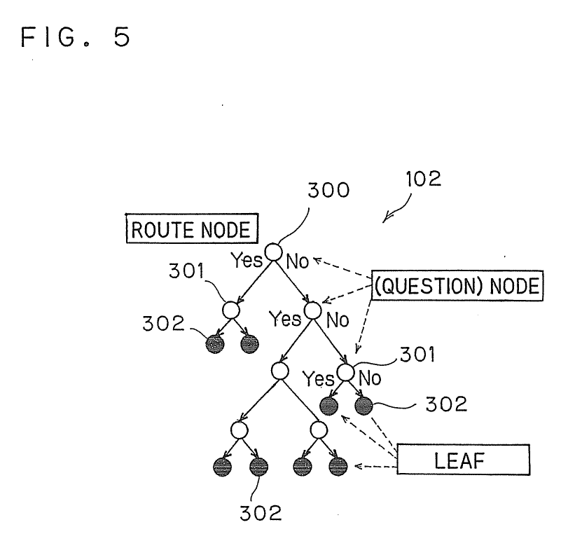

FIG. 5 shows an example of the decision tree 102. The decision tree 102 is a binary tree including a plurality of nodes 300 and 301 and a plurality of leaves 302, and the respective nodes are branched into two child nodes; “Yes” and “No” according to answers of questions. The leaves are each a node having no child node, that is, no branch.

Each of the nodes includes a question relating to the given acoustic feature value or non-acoustic feature value. Each of the leaves 302 stores a value learned in advance for outputting the likelihood of the input data with respect to the given state of the HMM 101.

The questions at the respective nodes of the decision tree 102 are determined on the basis of objective evaluation standard such as the rate of increase of the likelihood before and after the question, that is, before and after the branch. The term “questions” here means whether a certain feature value is larger than a certain threshold value or not or whether a certain feature value is a certain value or not, and all of the possible questions for all of the acoustic feature values and the non-acoustic feature values are evaluated on the basis of the objective evaluation standard, and the feature value and the threshold value which obtain the highest evaluation are decided. The process as described above is a course of leaning of the decision trees and is disclosed JP-A-2008-76730 and Teunen et al in detail.

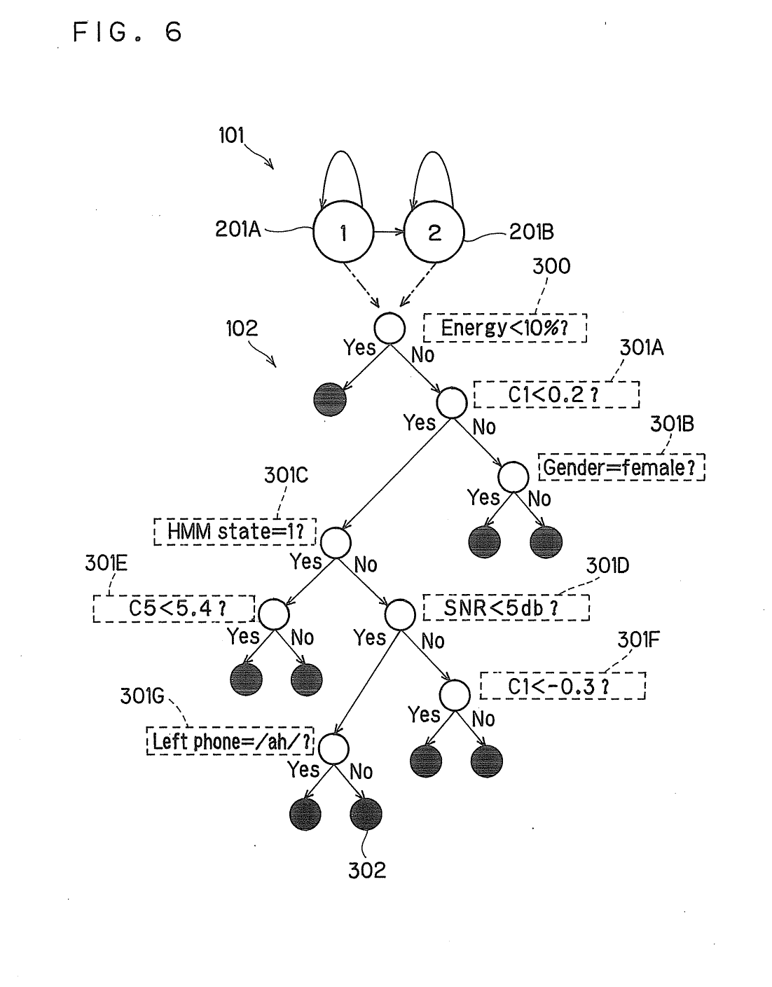

FIG. 6 is an explanatory drawing showing a detailed example of the decision tree 102.

In the decision tree 102 shown in FIG. 6, an acoustic model according to the first embodiment can output the likelihood 203 being different according to the gender, the SNR, a state of speech recognition, and a context of the input speech. The decision tree 102 is associated with two states of the HMM 101; a state 1 (201A) and a state 2 (201B), and performs leaning according to a learning process described later using the leaning data corresponding to the two states 201A and 2013, Feature values C1 and C5 respectively denote first and fifth PLP cepstrum coefficients. The root node 300, anode 301A and a node 301B are used in common between the state 1 (201A) and the state 2 (201B), and are shared between the two states. However, there is a question about the state at a node 301C, and nodes 301D to 301G after the node 301C are state-dependent. Therefore, a certain feature value is in common between the state 1 (201A) and the state 2 (201B), and certain different feature values are used depending on the state. Also, the number of feature values used depending on the state is different. In the example shown in FIG. 6, more feature values are used in the state 2 (201B) than the state 1 (201A), and the different likelihoods 203 are output depending on whether the SNR is lower than 5 dB or not, that is, whether the level of the ambient noise is high or not or, alternatively, whether a phoneme immediately before the corresponding phoneme is, for example, “/ah/” or not. In addition, whether the gender of the input speech is female or not is asked in the node 301B, so that the likelihoods 203 different depending on the gender can be output.

Parameters such as the number of nodes or the number of leaves in the decision tree 102, the feature values or the questions used in the respective nodes, and likelihoods outputted from the respective leaves are learned from the leaning data by a learning process, described later, and are optimized so that the likelihood or the ratio of recognition is maximized with respect to the leaning data. If the learning data includes enough data, and also if the speech signal is obtained in the actual environment which the speech recognition is executed, the decision tree 102 is also optimized in the actual environment.

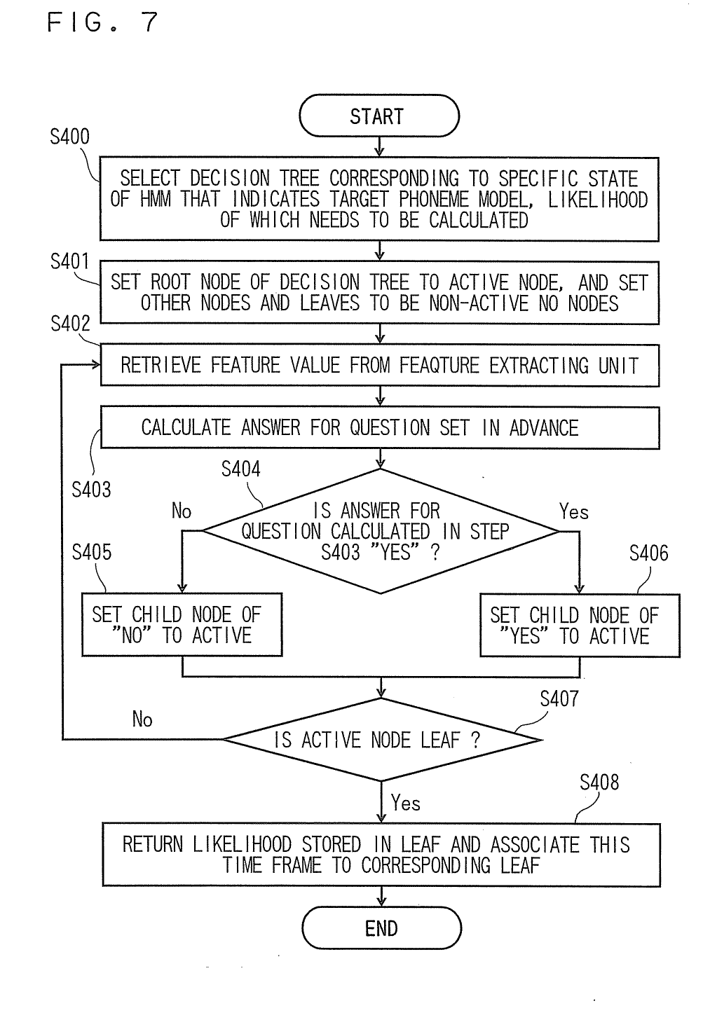

Subsequently, processes performed by the acoustic model of the decision tree 102 for calculating the likelihood 203 of the model with respect to received feature values are described in detail below with reference to a flowchart in FIG. 7.

In Step S400, the decoder 104 selects the decision tree 102 corresponding to a specific state 201 of the HMM 101 that indicates a target phoneme model, the likelihood of which needs to be calculated.

The decoder 104 sets the root node 300 to an active node, which is a node that can ask a question, and sets all other nodes and leaves to be non-active nodes in Step S401.

In Step S402, the decoder 104 retrieves a feature value from the feature extracting unit 103.

In Step S403, the decoder 104 inputs the feature value retrieved in Step S402 to the root node 300 set to the active node, and calculates an answer for the question set in advance.

In Step S404, the decoder 104 evaluates an answer for the question calculated in Step S403. If the answer for the question calculated in Step S403 is “Yes”, the procedure goes to Step S406. If the answer for the question calculated in Step S403 is “No”, the procedure goes to Step S405.

In Step S405, the child node indicating “No” is set to be an active node.

In Step S406, the child node indicating “Yes” is set to be an active node.

In Step S407, the decoder 104 determines whether the active node is the leaf 302 or not.

If the active node is the leaf 302 (“Yes” in Step S407″), it is not branched any more, and the procedure goes to Step S408. If the active node is not the leaf 302 (“No” in Step S407), the procedure goes back to Step S402, where evaluation of the next active node is performed.

In Step S408, the likelihood 203 stored in the leaf 302 is returned, and this time frame is associated with the corresponding leaf.

As described above, the feature values, the questions about the feature value, and the likelihood are written in the acoustic model using the decision tree, which depends on the input data. The decision tree can effectively optimize the questions and the likelihoods corresponding to the acoustic feature values or the higher-order feature values depending on the input speech or the state of recognition.

Subsequently, the learning process of the decision tree 102 will be described.

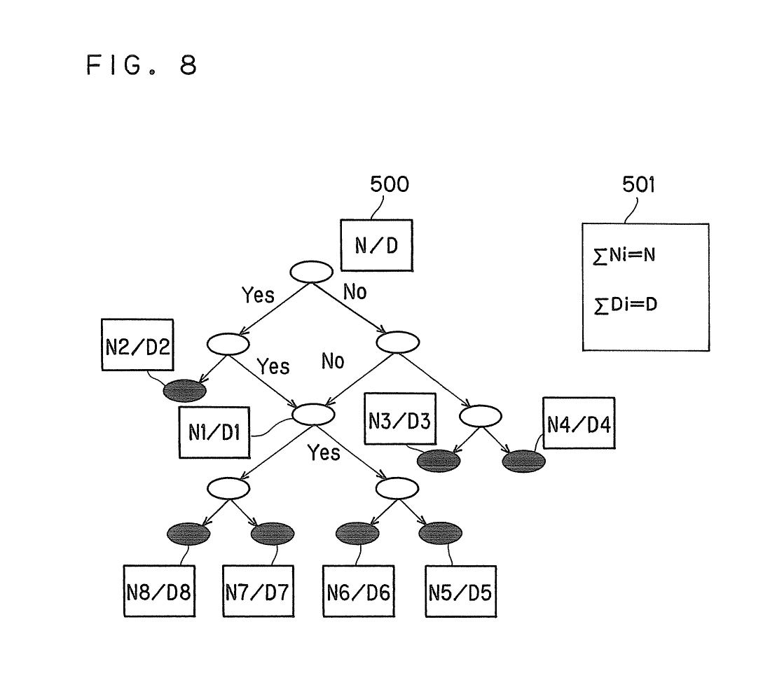

FIG. 8 shows processes of branching the nodes of the decision tree 102 and calculating the likelihoods by the learning data provided in the leaning process. Learning to the decision tree 102 is basically to determine a question, which is required for identifying whether an input sample belongs to a certain state 201 of the HMM 101 corresponding to the decision tree 102 as a target of learning or not, and the likelihood 203 by using the learning data that is separated into classes based on whether the input sample belongs to the state of the HMM 101 in advance or not.

The learning data is used for force alignment to determine which state of which HMM 101 the input sample corresponds to using the speech recognition method used in general, and labels samples belonging to the state as a true class and samples not belonging to the state as other class in advance. Learning of the HMM 101 may be performed in the same manner as in the related art.

First of all, as shown in FIG. 8, D leaning data is input into a root node 500. Here, N samples out of D leaning data are assumed to belong to the true class. In the root node 500, evaluation about questions set for all of the D samples by leaning in advance is performed, and the root node 500 is branched into childe nodes; “Yes” and “No” according to the answers for the questions. The branched data samples are evaluated at the next nodes, then branched repeatedly, and finally reach leaves which have no branch. Likelihood at L, which is the likelihood 203 at a certain leaf L is calculated according to the following expression (1), and is stored on the leaf-to-leaf basis.

$$Likelihood at L = \frac{\begin{matrix}number of data samples which belong \\ to the true class and reach Leaf L\end{matrix}}{\begin{matrix}total number of data samples \\ which reach Leaf L\end{matrix}} * \frac{1}{Prior} \qquad ( 1 )$$

Here, Prior is a prior probability of the true class and is calculated by N/D at the root node. The branching at each node is exclusively performed, and hence the total sum of the number of samples in the true class at all of the leaves matches the number of samples N in the true class at the root nodes, and the total sum of the number of samples in other classes matches (D-N).

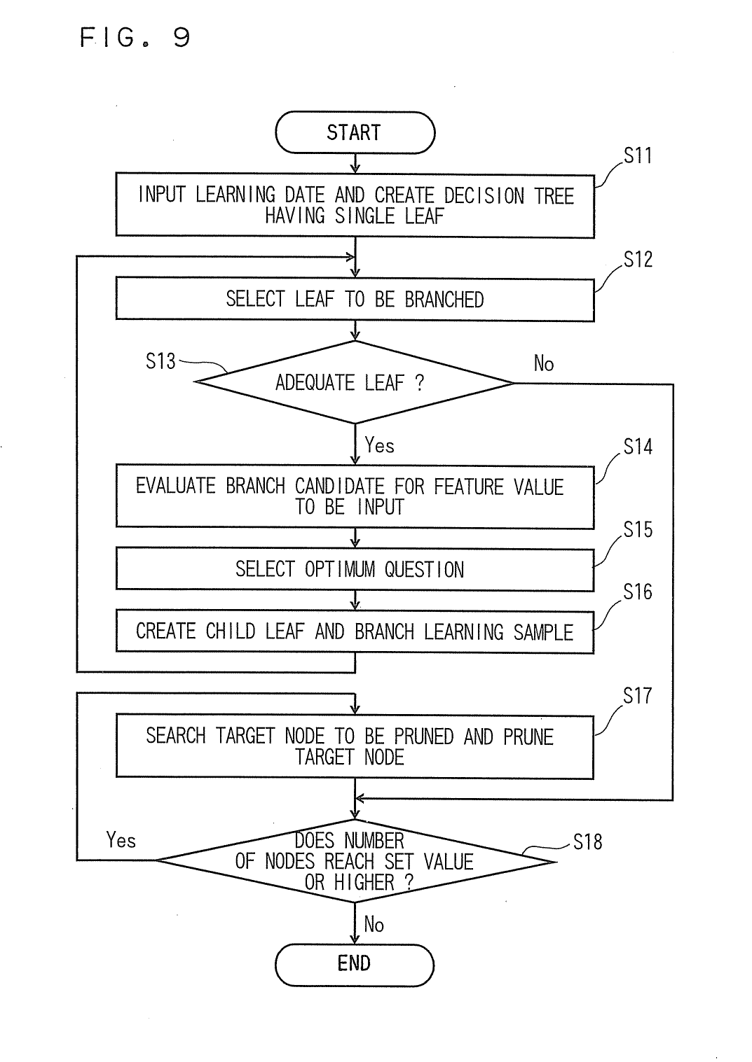

FIG. 9 is a flowchart of the leaning process in the decision tree 102. The processes in the leaning process will be described further in detail with reference to FIG. 9.

In Step S11, the leaning data of the state corresponding to the decision tree 102 to be learned is input and a new decision tree 102 having a single leaf is created. The decision tree 102 is created from a single leaf 302 by creating nodes and child nodes brunched from the leaf 302, and growing the child nodes repeatedly at every branch of the node.

In Step S12, a leaf to be branched is selected. The leaf 302 to be selected here is required to satisfy conditions such that the number of learning data included therein is more than a certain extent (for example, not less than 100), and that all of the leaning data included therein must not belong to a certain specific class.

In Step S13, whether the target leaf satisfies the conditions described above or not is determined. If the result of determination is “No” (“No” in Step S13), the procedure goes to Step S18. In contrast, when the result of determination is “Yes” (“Yes” in Step S13), the procedure goes to Step S14.

In Step S14, all of the possible questions are asked for all the feature values (leaning data) input to the target leaf 302, and all the branches obtained thereby (branches to the child nodes) are evaluated. The evaluation in Step S14 is performed on the basis of the increasing rate of the likelihood as a result of the branching. Here, the questions for the feature values as the learning data are differentiated according to the feature values such as those having a magnitude difference like the acoustic feature values and those having no difference in magnitude, but being expressed by classes like the gender or the noise types. For the feature values having the magnitude difference, a question as to whether it is larger than a certain threshold value or not is asked, and for the feature values having no magnitude difference, a question as to whether it belongs to a certain class or not is asked.

In Step S15, an optimum question which maximizes the evaluation is selected. In other words, all of the possible questions for all of the leaning data are evaluated, and a question which maximizes the increasing rate of the likelihood is selected.

In Step S16, the leaning data is branched to child leaves of “Yes” and child leaves of “No” according to the question selected in Step S15, and the likelihood 203 is calculated for each leaf from the learning data which belongs to each leaf using the expression (1) shown above.

Returning back to Step S12, the decoder 104 repeats again from Step S12 to Step S16 for a new leaf, and grows a new decision tree 102. Then, when there is no more leaf which satisfies the conditions for growth as a result of the determination in Step S13 (“No” in Step S13), the procedure goes to Step S18, where pruning is performed.

In Steps S17 and S18, the pruning is performed from the lowermost leafs upward while deleting the nodes in the reverse procedure from the growth of the tree.

In Step S17, all of the nudes having two child leaves are evaluated how much the likelihood is reduced when the branch of the corresponding node is deleted, and the node which demonstrates a minimum likelihood reduction is searched and pruned. This procedure is repeated until the number of nodes reaches a set value or higher (“Yes in Step S18) and, when the number of the nodes reaches the set value, leaning of the decision tree 102 for the first time is ended (“No” in Step S18).

When the above-described learning of the decision tree 102 is ended once, the force alignment is performed using the acoustic model which has learned the speech sample used for learning to update the leaning data. The likelihoods of the leaves of the decision tree 102 are relearned for the updated learning data, and are updated. The process as described above is repeated by the preset number of times or until the increasing rates of the entire likelihoods are reduced to a threshold level or lower, and the leaning is ended.

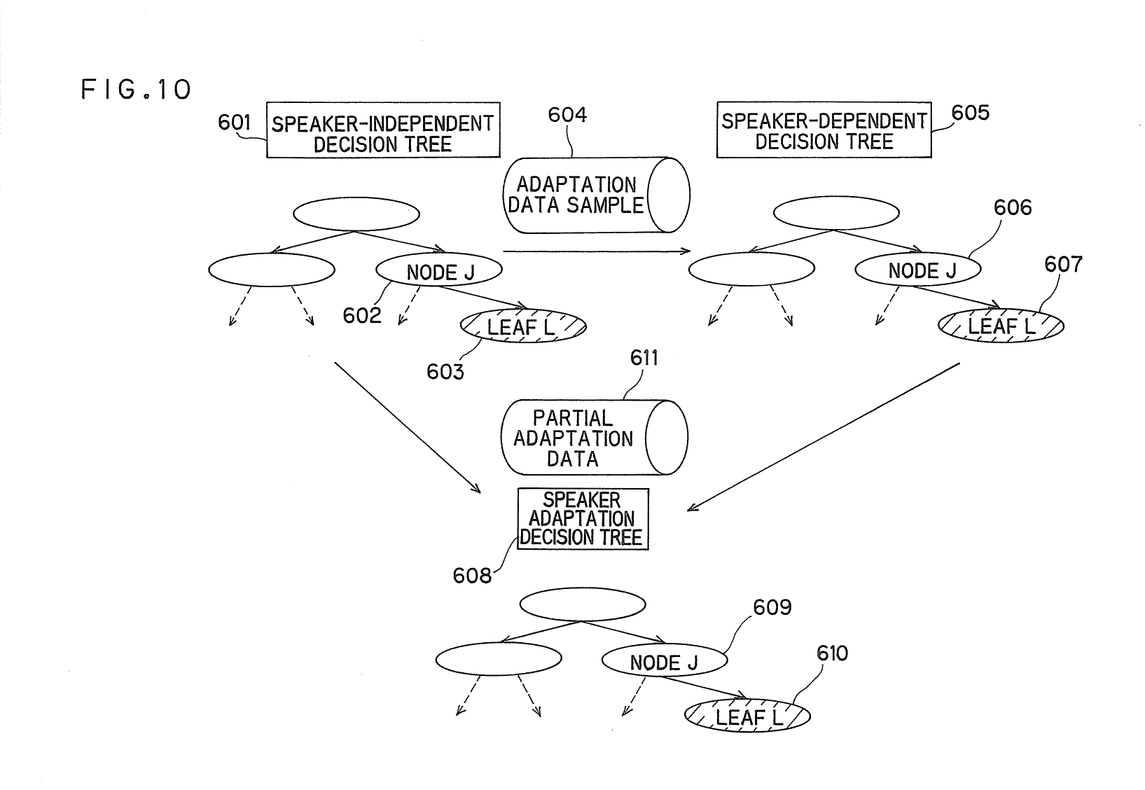

Referring now to FIG. 10, a speaker adaptation method of the acquiring unit 100 having the speaker adaptation unit according to the first embodiment will be described.

First of all, in order to adapt a speaker-independent decision tree 601 to the data of the speaker as a target of recognition, speaker adaptation data is required. The feature extracting unit 103 converts the input data which is a speech signal vocalized by a speaker who is a target of recognition into the feature value such as the MFCC used for the speech recognition. This feature value corresponds to the speaker adaptation data. The speaker adaptation data is divided into two parts; for example, apart of 80% of the speaker adaptation data (a speaker adaptation data sample 604) and a part of 20% (a partial speaker adaptation data sample 611), and the former is used for the speaker adaptation of parameters of the speaker-independent decision tree 601, and the latter is used for calculating a weight p for the speaker adaptation.

First of all, the acquiring unit 100 reforms the speaker-independent decision tree 601 into a speaker-dependent decision tree 605 using the speaker adaptation data sample 604. More specifically, the speaker adaptation data sample 604 is input from a root node of the speaker-independent decision tree 601 and is related to the receptive nodes and leaves while passing therethrough.

Subsequently, the acquiring unit 100 uses the sample 604 which reaches the each node to calculate again the question parameter thereof, that is, a threshold parameter thereof, and renew the old threshold parameter. A method of calculation is the same as that in the learning process.

Subsequently, the acquiring unit 100 calculates again the likelihood of the each leaf using the sample 604 which reaches the each leaf, and renews the parameter of the leaf. In other words, as the speaker adaptation, the questions or the like are changed so as to maximize the increasing rate of the likelihood.

Accordingly, the speaker-dependent decision tree 605 which depends on the speaker adaptation data sample 604 is created.

Subsequently, the acquiring unit 100 combines the parameters of the speaker-independent decision tree 601 and the speaker-dependent decision tree 605 to create a new decision tree adapted to the speaker adaptation data as a target of recognition, that is, a new speaker adaptation decision tree 608.

First of all, the combination of the threshold parameters as the question parameters of the respective nodes of the speaker-independent decision tree 601 and the respective nodes of the speaker-dependent decision tree 605 will be described.

The threshold parameter of a node J(602) of the speaker-independent decision tree is expressed by τⱼ^{S1} and the threshold parameter of a node J(606) of the speaker dependent decision tree is expressed by τⱼ^{SD}. At this time, the threshold parameter τⱼ^{SA} of a node J(609) to which the speaker adaptation decision tree 608 corresponds is created by a linear combination as the following expression (2)=

τⱼ^{SA}=β*τⱼ^{SI}+(1·β)*τⱼ^{SD} (2)

Here, the weight β of the linear combination is optimized using the partial speaker adaptation data sample 611. In the node J(602) of the speaker-independent decision tree 601, the weight β is determined so as to maximize the following expression (3)

(Nₚ^{CV}*log(likelihood of child node YES))+(Nₙ^{CV}*log(likelihood of child node NO)) (3)

where, Nₚ^{CV} is the number of data samples in the true class branched to the child node “Yes”, and Nₙ^{CV} is the number of data samples in the true class branched to the child node “No”.

Subsequently, the combination of the likelihood parameters of the leaves of the speaker-independent decision tree 601 and the leaves of the speaker-dependent decision tree 605 will be described.

A likelihood parameter of the each leaf L of the speaker adaptation decision tree 608 “Likelihood at L in SA” is calculated by the following expression (4) as the linear combination of the likelihoods of the leaves L to which the speaker-independent decision tree 601 and the speaker-dependent decision tree 605 correspond as in the case of the question parameters, and is stored in the each leaf L.

Likelihood at L in SA=α*l_{SI}+(1−α)*l_{SD} (4)

Here l^{s1} is the likelihood of the leaf L of the speaker-independent decision tree 601 and l^{SD} is the likelihood of the leaf L of the speaker-dependent decision tree 605.

The weight α is calculated by the expression (5) shown below.

$$α = \frac{{l}_{SI}}{{l}_{SI} + {l}_{SD}} \qquad ( 5 )$$

As in the first embodiment, the reason why the parameters of the speaker-independent decision tree 601 and the speaker-dependent decision tree 605 are combined for the speaker adaptation is as follows.

Since the threshold parameter or the likelihood parameter of the speaker-dependent decision tree 605 are estimated from the speaker adaptation data which is significantly less than the threshold parameter or the likelihood parameter of the speaker-independent decision tree 601, if only the threshold parameter or the likelihood parameter of the speaker-dependent decision tree 605 are used, the performance for the input data which is not included in the speaker adaptation data may be deteriorated.

According to the first embodiment, by combining the threshold parameters or the likelihood parameters of the speaker-independent decision tree 601 learned from a large amount of the speaker adaptation data and the speaker-dependent decision tree 605 created from the speaker adaptation data sample 604, the performance deterioration is prevented for various input data, and stable improvement of the performance is enabled.

The partial speaker adaptation data sample 611 is used for guaranteeing the performance when combining two types of parameters, and the weights α and β for the combination are advantageously optimized.

In the first embodiment, the speaker-independent decision tree 601 is created using a large amount of speaker data. Then, for example, the question parameter of the each node and the likelihood parameter of the each leaf of the speaker-independent decision tree 601 are rewritten using, for example, the speaker adaptation data sample 604 of a speaker X to crease the speaker-dependent decision tree 605. Then, the speaker-independent decision tree 601 and the speaker-dependent decision tree 605 are combined to create the speaker adaptation decision tree 608. In other words, the speaker adaptation for the speaker X is achieved by linearly combining the two types of parameters of the speaker-independent decision tree 601 and the speaker-dependent decision tree 605. The weight β of the linear combination is optimized using the partial speaker adaptation data sample 611.

Therefore, according to the first embodiment, the speaker adaptation to the data of the target speaker of acoustic model recognition on the basis of the speaker adaptation decision tree is achieved, whereby improvement of the recognition performance of the speech recognition is achieved.

### Second Embodiment

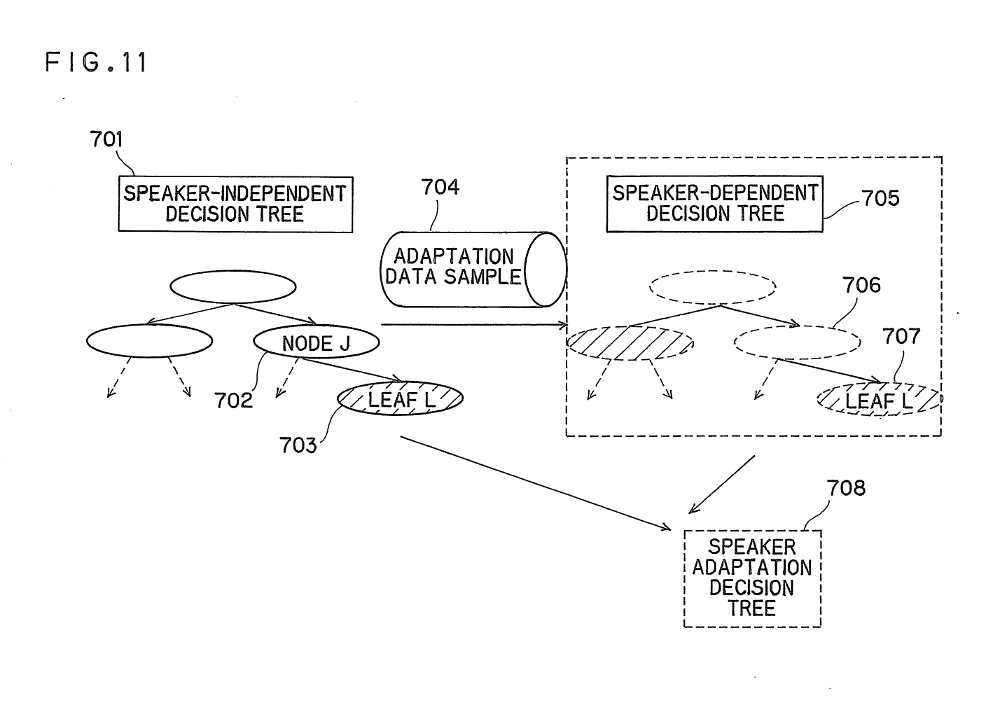

Referring now to FIG. 11, a speaker adaptation apparatus according to a second embodiment of the invention will be described.

In the speaker adaptation apparatus in the second embodiment, a speaker-independent decision tree 701 is created as in the first embodiment. Subsequently, a speaker-dependent decision tree 705 is created as in the first embodiment. The speaker-dependent decision tree 705 may be created as a decision tree which is completely new including the structure of the decision tree using a speaker adaptation data 704, or may be created by rewriting the parameters of the speaker-independent decision tree 701 according to the speaker adaptation data 704 as in the first embodiment.

The second embodiment is different from the first embodiment as follows.

In the first embodiment, parameters of the speaker-independent decision tree 601 and the speaker-dependent decision tree 605 are combined to create the speaker adaptation decision tree 608.

In contrast, in the second embodiment, the speaker adaptation decision tree is not created, and the acoustic model includes the speaker-independent decision tree 701 and the speaker-dependent decision tree 705.

Therefore, in the second embodiment, the speaker adaptation likelihood “Likelihood of X given SA tree” is calculated as follows.

First of all, the feature value sample X of the speaker X is input to both of the speaker-independent decision tree 701 and the speaker-dependent decision tree 705, and the respective likelihoods are output.

Subsequently, the likelihood of the speaker-independent decision tree 701 “Likelihood of sample X given SI tree” and the likelihood of the speaker-dependent decision tree 705 “Likelihood of sample X given SD tree” are linearly combined, and the likelihood adapted to the speaker X “Likelihood of sample X given SA tree” is calculated with the expression (6) shown below.

Likelihood of sample X given SA tree=α×Likelihood of sample X given SI tree+(1−α)×Likelihood of sample X given SD tree (6)

The weight α of the linear combination is calculated by the expression (7) shown below using the likelihoods l_{S1}(i) and l_{S1}(i) obtained by inputting the respective samples i of an adaptation data B as the partial sample of the speaker adaptation data 704 to the speaker-independent decision tree 701 and the speaker-dependent decision tree 705.

$$a = \frac{{\sum }_{i} {l}_{SI} ( i )}{{\sum }_{i} {l}_{SI} ( i ) + {\sum }_{i} {l}_{SD} ( i )} \qquad ( 7 )$$

In the second embodiment, the speaker-independent decision tree 701 and the speaker-dependent decision tree 705 are created as in the first embodiment. The speaker adaptation is achieved by linearly coupling the likelihood parameters of the speaker-independent decision tree 701 and the speaker-dependent decision tree 705 created as described above. The weight of the linear combination is optimized using the partial sample of the speaker adaptation data 704.

Therefore, according to the second embodiment, the speaker adaptation to the data of the target speaker of acoustic model recognition on the basis of the two decision trees is achieved, whereby improvement of the recognition performance of the speech recognition is achieved.

### Third Embodiment

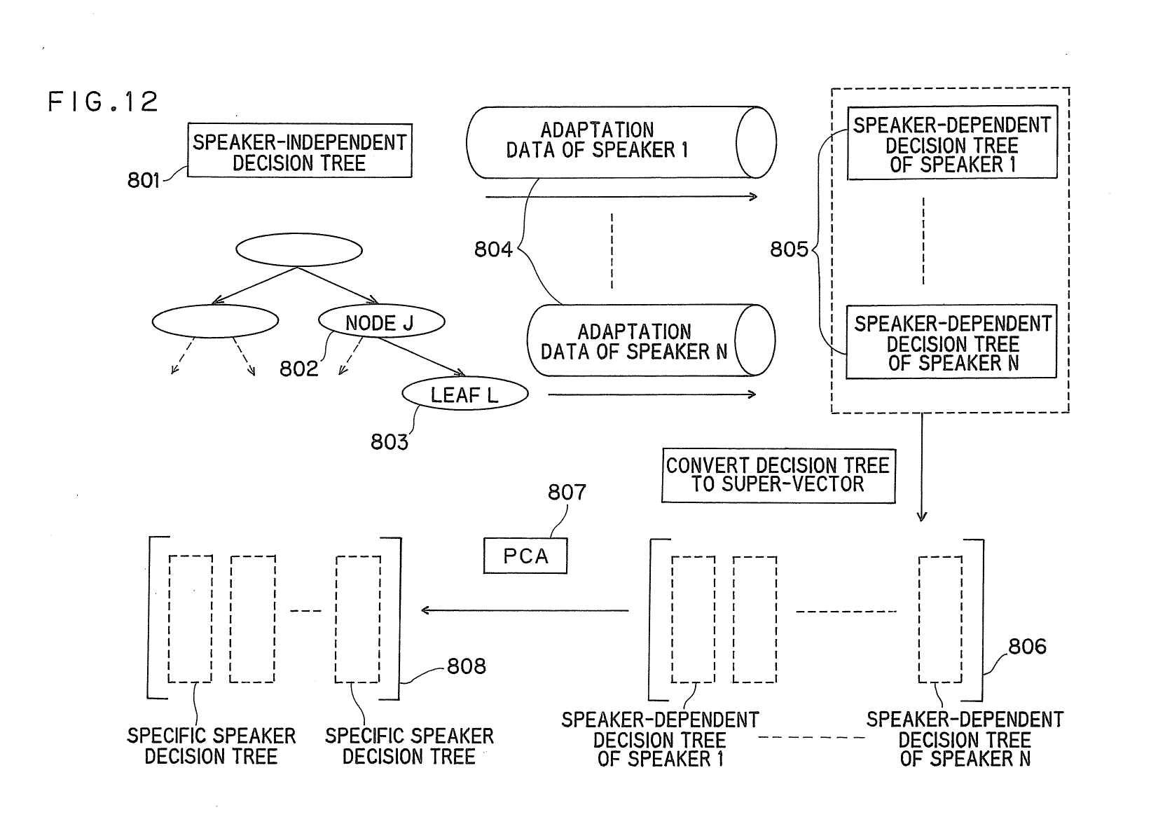

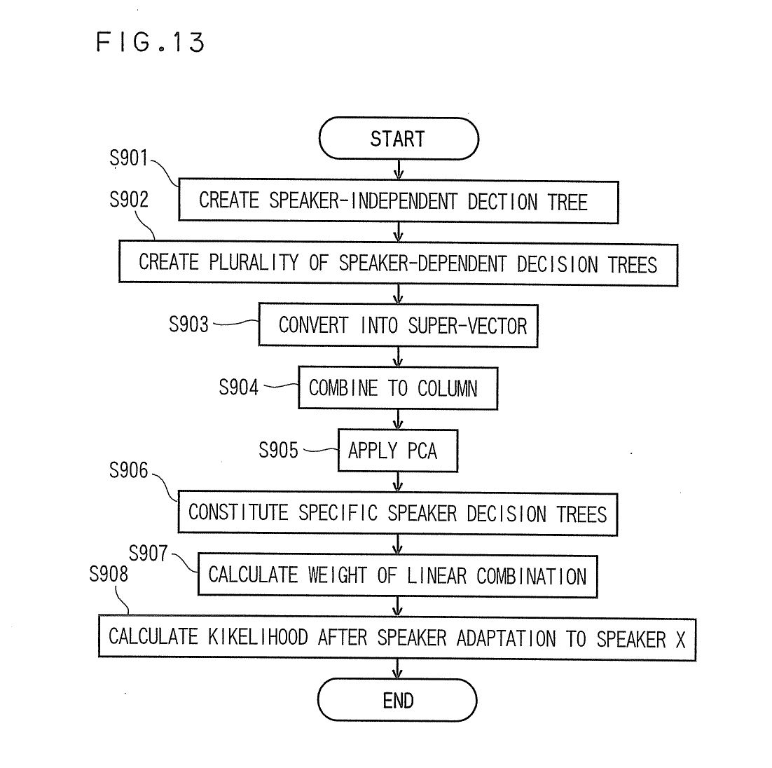

Referring now to FIG. 12 and FIG. 13, the speaker adaptation apparatus according to a third embodiment of the invention will be described.

The speaker adaptation apparatus in the third embodiment realizes the speaker adaptation by creating a specific speaker decision tree from a plurality of speaker-dependent decision trees 805 and combining the same, and adapts the acoustic model to the data of the speaker by combining both of the question parameter and the likelihood parameter of the speaker adaptation decision tree at the each node and the each leaf in a common weight.

Referring now to an explanatory drawing in FIG. 12 and a flowchart in FIG. 13, the speaker adapting method according to the third embodiment will be described.

In Step S901, the acquiring unit 100 creates a speaker-independent decision tree 801 as in the first embodiment.

In Step S902, as in the first embodiment, the acquiring unit 100 rewrites the parameter of the speaker-independent decision tree 801 on the basis of each speaker adaptation data 804 to create the speaker-dependent decision tree 805 for each of a plurality of speakers 1 to N.

In Step S903, the acquiring unit 100 converts the parameter of the speaker-dependent decision tree 805 of each of the speakers 1 to N into a form of one vector (hereinafter, referred to as “super-vector”). Accordingly, super-vectors for the speakers 1 to N are obtained.

In Step S904, the acquiring unit 100 aligns the super-vectors of the speakers 1 to N into a row, and combines the same to a column 806. In FIG. 12, each of the column vectors of the column 806 corresponds to the super-vector of each of the speakers 1 to N.

In Step S905, the acquiring unit 100 applies PCA (Principal Component Analysis) 807 to the column 806 to remove redundancies existing among parameters of the respective speakers.

In Step S906, the acquiring unit 100 constitutes a plurality of specific speaker decision trees each having the specific parameter compressed to remove the redundancy as a result of PCA 807. In FIG. 12, the each column vector in a column 808 corresponds to the parameter of the specific speaker decision tree.

In the Step S907, the acquiring unit 100 calculates a weight Wi of the linear combination in the same manner as the second embodiment.

In Step S908, the acquiring unit 100 linearly combines likelihoods Li of the plurality of specific speaker decision trees i using the weight Wi by the expression (8) shown below to calculate a likelihood Lx adapted to the speaker X for the feature value of the inputted speaker X.

Lx=ΣWi×Li (8)

As described above, in the third embodiment, the speaker-dependent decision tree 805 is created for the each speaker using the each speaker adaptation data 804. Then, the PCA 807 is applied to the parameters of the respective created speaker-dependent decision trees 805 to create a plurality of specific speaker decision trees. The speaker adaptation is realized by linearly combining the likelihoods of the specific speaker decision trees. The weight of the linear combination is optimized using the speaker adaptation data.

Therefore, according to the third embodiment, the speaker adaptation to the data of the target speaker of acoustic model recognition on the basis of the specific speaker decision tree is achieved, whereby improvement of the recognition performance of the speech recognition is achieved.

The invention is not limited to the embodiments described above, and various modifications may be made without departing the scope of the invention. For example, in the respective embodiments described above, the questions are changed to maximize the increasing rate of the likelihood. However, the invention is not limited thereto, and the questions may be changed so as to increase the recognition ratio of the speech. Also, in the respective embodiments described above, the respective parameters are combined by the linear combination using the weight. However, the invention is not limited thereto, and combining parameters using the weight also includes calculating an integrated value of weighted parameters, or applying an exponential function to the weight, multiplying the parameters by the applied value to obtain the total sum.

What is claimed is:

1. A speaker adaptation apparatus comprising:
an acquiring unit configured to acquire an acoustic model including HMMs and decision trees for estimating what type of the phoneme or the word is included in a feature value used for speech recognition, the HMMs having a plurality of states on a phoneme-to-phoneme basis or a word-to-word basis, and the decision trees being configured to reply to questions relating to the feature value and output likelihoods in the respective states of the HMMs; and
a speaker adaptation unit configured to adapt the decision trees to a speaker, the decision trees being adapted using speaker adaptation data vocalized by the speaker of an input speech.

2. The apparatus according to claim 1, wherein
the speaker adaptation unit combines a parameter of the decision tree, a parameter of a speaker-independent decision tree which does not depend on the speaker, and a parameter of a speaker-dependent decision tree which depends on the speaker created using the speaker adaptation data to adapt the speaker.

3. The apparatus according to claim 2, wherein
the parameter includes a question parameter relating to the question and a likelihood parameter indicating the likelihood, and
the speaker adaptation unit uses the speaker adaptation data to combine the question parameters of respective nodes and the likelihood parameters of leaves of the speaker-independent decision trees with the question parameters of respective nodes and the likelihood parameters of leaves of the speaker-dependent decision tree respectively and create a speaker adaptation decision tree as a decision tree adapted to the speaker and achieves the speaker adaptation.

4. The apparatus according to claim 2, wherein
the speaker adaptation unit combines the parameter of the speaker-independent decision tree and the parameter of the speaker-dependent decision tree on the basis of a weight determined by using the speaker adaptation data to adapt the speaker.

5. The apparatus according to claim 1, wherein
the speaker adaptation unit
uses the speaker adaptation data of each of a plurality of the speakers to create respective speaker-dependent decision trees,
uses parameters of the respective speaker-dependent decision trees to create a plurality of specific speaker decision trees by a PCA, and
uses the speaker adaptation data to combine the likelihoods of the respective specific speaker decision trees to adapt the speakers.

6. A program stored in a computer readable medium, the program causing the computer to implement:
an acquiring function to acquire an acoustic model including HMMs and decision trees for estimating what type of the phoneme or the word is included in a feature value used for speech recognition, the HMMs having a plurality of states on a phoneme-to-phoneme basis or a word-to-word basis, and the decision trees being configured to reply to questions relating to the feature value and output likelihoods in the respective states of the HMMs; and
a speaker adaptation function to adapt the decision trees to a speaker, the decision trees being adapted using speaker adaptation data vocalized by the speaker of an input speech.

7. The program according to claim 6, wherein the speaker adaptation function combines a parameter of the decision tree, a parameter of a speaker-independent decision tree which does not depend on the speaker, and a parameter of a speaker-dependent decision tree which depends on the speaker created using the speaker adaptation data to adapt the speaker.

8. The program according to claim 7, wherein
the parameter includes a question parameter relating to the question and a likelihood parameter indicating the likelihood, and
the speaker adaptation function uses the speaker adaptation data to combine the question parameters of respective nodes and the likelihood parameters of leaves of the speaker-independent decision trees with the question parameters of respective nodes and the likelihood parameters of leaves of the speaker-dependent decision tree respectively and create a speaker adaptation decision tree as a decision tree adapted to the speaker and achieves the speaker adaptation.

9. The program according to claim 7, wherein
the speaker adaptation function combines the parameter of the speaker-independent decision tree and the parameter of the speaker-dependent decision tree on the basis of a weight determined by using the speaker adaptation data to adapt the speaker.

10. The program according to claim 6, wherein
the speaker adaptation function
uses the speaker adaptation data of each of a plurality of the speakers to create respective speaker-dependent decision trees,
uses parameters of the respective speaker-dependent decision trees to create a plurality of specific speaker decision trees by a PCA, and
uses the speaker adaptation data to combine the likelihoods of the respective specific speaker decision trees to adapt the speakers.

11. A speaker adaptation method comprising:
acquiring an acoustic model including HMMs and decision trees for estimating what type of the phoneme or the word is included in a feature value used for speech recognition, the HMMs having a plurality of states on a phoneme-to-phoneme basis or a word-to-word basis, and the decision trees being configured to reply to questions relating to the feature value and output likelihoods in the respective states of the HMMs; and
adapting the decision trees to a speaker, the decision trees being adapted using speaker adaptation data vocalized by the speaker of an input speech.
